(19) United States
(12) Patent Application Publication
(10) Pub. No.: US 2017/0267024 A1
(43) Pub. Date: Sep. 21, 2017

(54) BICYCLE RATCHET HUB ASSEMBLY WITHOUT RESILIENT PART

(71) Applicants: KUEI SHIANG PENG, CHANGHUA COUNTY (TW); WEN CHUN PENG, TAICHUNG CITY (TW)

(72) Inventors: KUEI SHIANG PENG, CHANGHUA COUNTY (TW); WEN CHUN PENG, TAICHUNG CITY (TW)

(21) Appl. No.: 15/075,399

(22) Filed: Mar. 21, 2016

(51) Int. Cl. B60B 27/04; F16D 27/00; B60B 27/02

(52) U.S. Cl. CPC B60B 27/047; B60B 27/023; F16D 27/00; F16D 41/30

(57) ABSTRACT

A bicycle ratchet hub assembly includes a ratchet unit and a damping unit located between the hub and the socket unit. The ratchet unit has a ratchet ring in the hub. Multiple recesses are defined in the seat and each have a pawl pivotably located therein. The damping unit is located between the axle and the hub, and includes a damping member which has slots defined therein. A pin protrudes from each of the pawls and movably extends through the corresponding slot. By the damping feature of the damping member, the damping member delays a period of time to begin to rotate, and the pins of the pawls move in the slots and the pawls are pivoted outward to be engaged with the ratchet teeth of the ratchet unit without using any resilient part. A magnetic driving device located in the hub to attract the pawls to be pivoted outward.

### BACKGROUND OF THE INVENTION

1. Fields of the invention

The present invention relates to a bicycle ratchet hub assembly, and more particularly, to a bicycle ratchet hub assembly whose pawls are pivoted to be engaged with the ratchet ring without using any resilient part.

2. Descriptions of Related Art

The conventional hub is located at the center of the wheel rim and is connected with the front fork or the chain stays so that the wheel can smoothly rotate. The conventional hub is usually cooperated with a socket. The hub has the axle, the ratchet unit, the bearings and other positioning members received therein. When treading the pedals to activate the chain which drives the freewheel gear cluster and the hub so that the rear wheel rotates to move the bicycle forward.

The conventional way to move a bicycle forward is to rotate the pedals which rotates the chain wheel, and a chain is driven by the rotation of the chain wheel to activate the freewheel gear cluster connected to the hub of the rear wheel. In order to keep the bicycle moving forward while the pedals are not rotated, a one-way ratchet unit is located between the hub and the socket unit.

The ratchet unit comprises a ratchet ring with multiple ratchet teeth defined in the inner periphery of the ratchet ring, pawls and resilient parts, wherein the pawls are pivotably connected to the socket and cooperated with the resilient parts so that the pawls are normally located the outward positions to be engaged with the ratchet teeth of the ratchet ring.

By the engagement between the pawls and the ratchet ring, when operating the pedals of the bicycle, the hub together with the socket are rotated to move the bicycle forward. When the pedals are not rotated, the freewheel gear cluster, the socket and the pawls are not rotated, however, the ratchet ring and the hub keep on rotating. The ratchet teeth then move over the pawls and pushes the pawls inward, but the pawls are biased outward by the resilient parts, so that the rotation of the ratchet ring hits the pawls to generate click sounds.

It is obvious that the pivotal action of the pawls is important for engaging the pawls with the ratchet teeth or for disengaging the pawls from the ratchet teeth. Furthermore, how quick that the pawls are engaged with or disengaged from the ratchet teeth affects the operation of the bicycle. One of the conventional ways to engage the pawls with or disengage the pawls from the ratchet teeth is to install a magnet on the pawl so as to be attracted to the ratchet teeth.

The other one of the conventional ways to engage the pawls with or disengage the pawls from the ratchet teeth is to install a resilient part to keep the pawl being normally pivoted outward. The resilient part can be a resilient ring, a resilient plate or any shape of a resilient part.

The resilient part may reach its elastic fatigue point after frequent operations, when the resilient part fails to properly pivot the pawl outward, the engagement between the pawls and the ratchet teeth does not function as expected. This reduces the efficiency of force transmission and even makes the ratchet ring not be rotated. Besides, the resilient parts are made by thin wires which may be broken or deformed to delay the action of the pawls. The maintenance for the resilient parts is complicated because the whole set of the hub assembly has to be detached. Furthermore, the impact between the pawls and the ratchet teeth increases the friction of the rotation of the wheel, so that the wheel cannot stay at rotational status for a period of time when the pedals are not rotated.

Applicant has designed a ratchet device without using resilient member or magnetic member, such as disclosed in Taiwan 103213202 utility model application, wherein a ratchet unit and a damping unit are located between the hub and the socket. The damping unit includes a pre-set damping feature to delay a period of time to allow the transmission guiding unit to guide the pawls to be pivoted outward without any resilient member. When the pedals are not treaded, the pawls do not pivot outward by themselves to reduce friction and to increase the initial rotational force to the hub. Also the noise of the rotation of the wheel is reduced, and the life of the pawls is increased.

However, when the parts that provide the delay feature worn out after a period of time of use, the feature of delay is gradually reduced, so that when the pawls are pivoted outward, the travel distance of the pawl is not long enough to precisely engage with the ratchet teeth to generate force. Hub or other related parts need to be replaced, and this can be costly.

The present invention intends to provide a bicycle ratchet hub assembly to eliminate the shortcomings mentioned above.

### SUMMARY OF THE INVENTION

The present invention relates to a bicycle ratchet hub assembly and comprises a hub and an axle extends through the hub which is rotatable relative to the axle. A ratchet unit is connected to one end of the hub and has a seat and a socket, wherein the socket is to be connected with a freewheel gear cluster. A ratchet unit is located between the hub and the socket unit. The ratchet unit has a ratchet ring located therein. The ratchet ring has multiple ratchet teeth defined in the inner periphery thereof. Multiple recesses are defined in the seat and each of the recesses has a pawl pivotably engaged therewith. The pawls are pivoted radially and outward from the recesses so as to be engaged with the ratchet teeth of the ratchet ring to drive the hub. A damping unit has a damping member mounted to the axle and located in the hub. A damping feature is formed between the axle and the damping member. A guiding unit has multiple slots defined in the damping member. Each of the pawls has a pin which movably extends through the slot corresponding thereto. The damping member provides a force to the pawl. Each of the pin is moved within the slot to guide the pawl to be engaged with or to be disengaged from the ratchet teeth of the ratchet ring. The damping unit delays the rotational action so as to pivot the pawls outward without using any resilient part. A magnetic driving device is provided to attract the pawls to be pivoted outward to improve the efficiency of transmission when suddenly treading the pedals, and to reduce friction and noise, also to increase the life of use of the pawls.

The primary object of the present invention is to provide a bicycle ratchet hub assembly which has a damping unit which guides the pawls to be pivoted outward to be engaged with the ratchet teeth without using any resilient part.

Another object of the present invention is to provide a bicycle ratchet hub assembly which eliminates the shortcomings of the use of the resilient parts and the maintenance cost can be reduced.

Yet another object of the present invention is to provide a bicycle ratchet hub assembly wherein the pawls are located within the recesses when the pawls are not used to driving the hub, so as to reduce the friction between the ratchet teeth and the pawls.

A further object of the present invention is to provide a bicycle ratchet hub assembly which provides the magnetic driving device without using any resilient part, the magnetic driving device attracts the pawls to pivot outward. The pawls can be quickly engaged with the ratchet teeth of the ratchet ring to generate transmission force immediately.

Another object of the present invention is to provide a bicycle ratchet hub assembly which provides the magnetic force from the magnetic driving device to pivot the pawls, and the pawls do not hit the ratchet teeth hardly to reduce the friction between the pawls and the ratchet teeth. The noise is reduced as well.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle ratchet hub assembly of the present invention;

FIG. 2 is an exploded view of the bicycle ratchet hub assembly of the present invention;

FIG. 3 is a partial cross sectional view of the bicycle ratchet hub assembly of the present invention;

FIG. 4 is an enlarged cross sectional view of the bicycle ratchet hub assembly of the present invention;

FIG. 5 is an end cross sectional view to show one status of the pawls and the ratchet ring of the bicycle ratchet hub assembly of the present invention;

FIG. 6 is an end cross sectional view to show another one status of the pawls and the ratchet ring of the bicycle ratchet hub assembly of the present invention;

FIG. 7 is an end cross sectional view to show yet another one status of the pawls and the ratchet ring of the bicycle ratchet hub assembly of the present invention;

FIG. 8 is an end cross sectional view to show a further one status of the pawls and the ratchet ring of the bicycle ratchet hub assembly of the present invention;

FIG. 9 is an end cross sectional view of the bicycle ratchet hub assembly of the present invention, wherein the pedals are rotated;

FIG. 10 is an end cross sectional view of the bicycle ratchet hub assembly of the present invention, wherein the pedals are not rotated;

FIG. 11 is another end cross sectional view of the bicycle ratchet hub assembly of the present invention, wherein the pedals are not rotated;

FIG. 12 shows the operation of the magnetic driving device of the present invention;

FIG. 13 is an exploded view of the second embodiment of the bicycle ratchet hub assembly of the present invention;

FIG. 14 is an enlarged cross sectional view of the second embodiment of the bicycle ratchet hub assembly of the present invention;

FIG. 15 is an exploded view of the third embodiment of the bicycle ratchet hub assembly of the present invention;

FIG. 16 is an enlarged cross sectional view of a portion of the third embodiment of the bicycle ratchet hub assembly of the present invention;

FIG. 17 is an exploded view of the fourth embodiment of the bicycle ratchet hub assembly of the present invention;

FIG. 18 is an enlarged cross sectional view of a portion of the fourth embodiment of the bicycle ratchet hub assembly of the present invention;

FIG. 19 is an exploded view of the fifth embodiment of the bicycle ratchet hub assembly of the present invention;

FIG. 20 is an enlarged cross sectional view of a portion of the fifth embodiment of the bicycle ratchet hub assembly of the present invention, and

FIG. 21 is an exploded view of the sixth embodiment of the bicycle ratchet hub assembly of the present invention.

### DETAILED DESCRIPTION OF THE PREFERRED EMBODIMENT

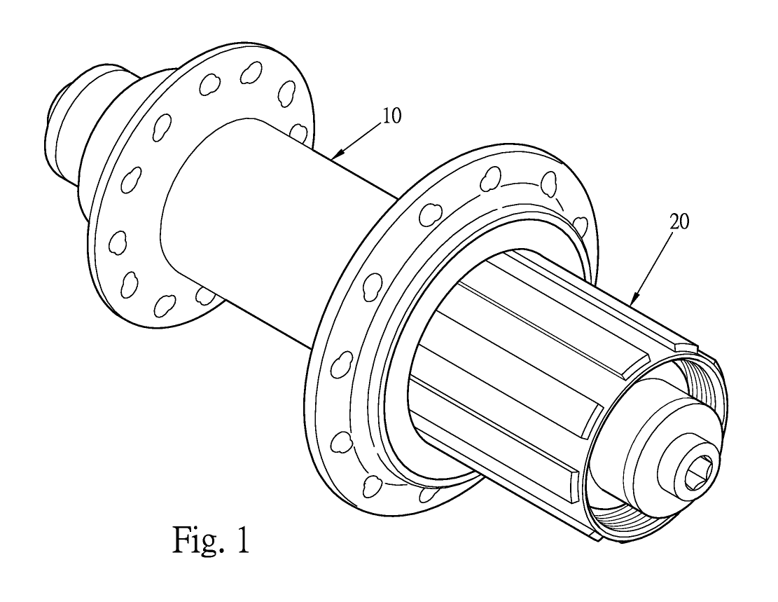

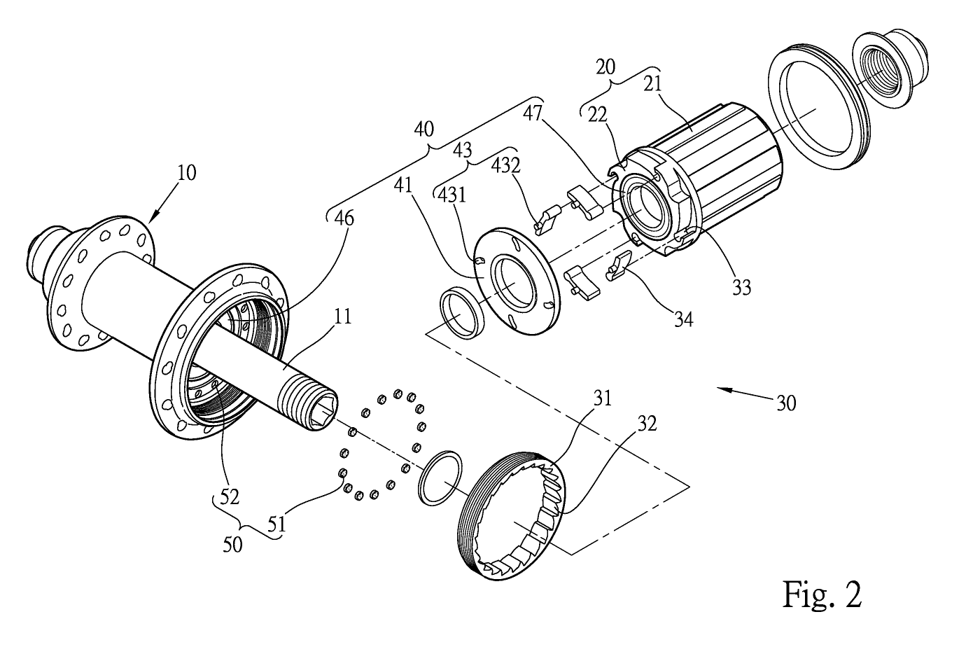

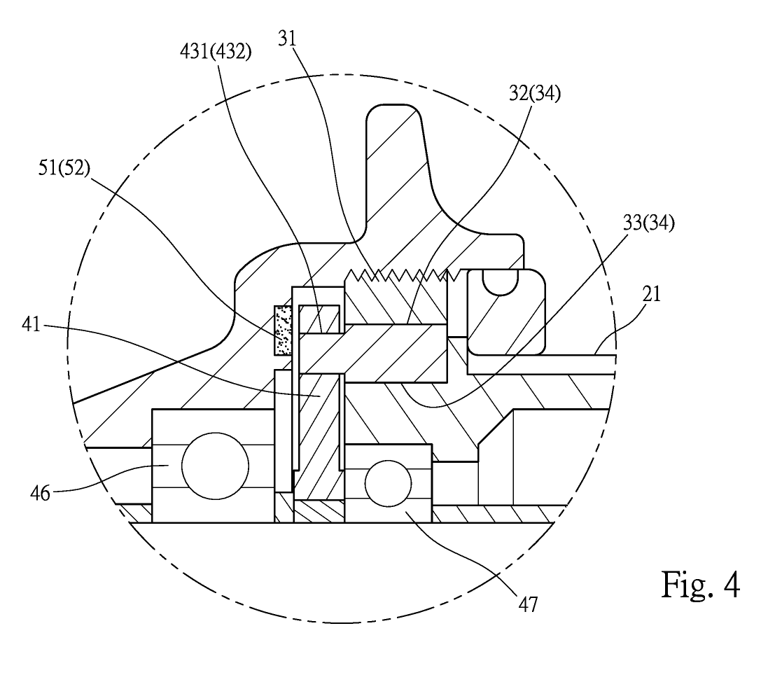

Referring to FIGS. 1 to 6, the bicycle ratchet hub assembly of the present invention comprises a hub 10, a socket unit 20 connected to the hub 10, a ratchet unit 30 and a damping unit 40.

The axle 11 extends through the hub 10 which is rotatable relative to the axle 11. The hub 10 is connected with multiple spokes which are connected to a wheel rim.

The socket unit 20 is connected to one end of the hub 10 and has a seat 22 and a socket 21, wherein the socket 21 is to be connected with a freewheel gear cluster.

The ratchet unit 30 is located between the hub 10 and the socket unit 20. The ratchet unit 30 has a ratchet ring 31 located therein. The ratchet ring 31 has multiple ratchet teeth 32 defined in the inner periphery thereof. Multiple recesses 33 are defined in the seat 22 and each of the recesses 33 has a pawl 34 pivotably engaged therewith. The pawls 34 are pivoted radially and outward from the recesses 33 so as to be engaged with the ratchet teeth 32 of the ratchet ring 31 to drive the hub.

The damping unit 40 has a damping member 41 mounted to the axle 11 and located in the hub 10. A damping feature is formed between the axle 11 and the damping member 41. An O-ring 42 is located between the axle 11 and the damping member 41 so as to generate the damping feature. A guiding unit 43 has multiple elongate slots 431 defined in the damping member 41. Each of the pawls 34 has a pin 432 which movably extends through the slot 431 corresponding thereto. The damping member 41 provides a force to the pawl 34. Each of the pin 432 is moved within the slot 431 to guide the pawl 34 to be engaged with or to be disengaged from the ratchet teeth 32 of the ratchet ring 31. When the pin 432 moves toward either one of the two ends of the slot 431, the force is larger than the damping feature between the axle 11 and the damping member 41, the damping member 41 is rotated so that there is a delay between the rotation of the socket 21 and the damping member 41. When the socket unit 20 is rotated in the direction that the ratchet 30 is rotated so as to rotate the hub 10, the pawls 34 each have one end moved with the rotation of the socket 21, and the other end of the pawl 34 moves along the slot 431 from the inner end to the outer end of the slot 431 whole the damping member 41 is temporarily not rotated, such that the pawl 34 is pivoted outward to be engaged with the ratchet teeth 32 to drive the hub 10.

A magnetic driving device 50 is located between the hub 10 and the ratchet unit 30. The hub 10 having at least one magnetic member 51 connected thereto which is located close to a position where the pawl 34 pivots outward. The at least one magnetic member 51 provides a attracting force to the pawl 34 so that when the pawl 34 pivots outward, the at least one magnetic member 51 attracts the pawl 34 to pivot outward. Multiple reception recesses 52 are defined in the hub 10 so as to receive the magnetic members 51.

The guiding unit 43 guides the pawls 34 to pivot outward during the delay of rotation due to the damping member 41 without any resilient part. The magnetic driving device 50 attract the pawls 34 to pivot outward to increase the efficiency of transmission when the pedals are suddenly treaded. The friction, noise and maintenance fee are reduced as well. The life of use of the pawls 34 is prolonged.

Because of the delay between the rotation of the socket 21 and the damping member 41, the pawls 34 are pivoted outward within the slots 431 without any resilient part. The pawls 34 do not pivoted outward when the pedals are not rotated, so that the ratchet teeth 32 do not hit the pawls 34 such that no noise is generated, and the hub 10 can rotate for a longer period of time.

When in assembling, the reception recesses 52 are integrally formed in the hub 10 and the magnetic members 51 are respectively received in the reception recesses 52. The seat 22 is integrally formed with the socket 21, and the ratchet teeth 23 are formed integrally with the ratchet ring 31. The ratchet ring 31 is connected to the seat 22, and the pawls 34 are pivotably connected to the recesses 33 of the seat 22. The pin 432 of each pawl 34 extends through the slot 431 corresponding thereto. The axle 11 extends through the hub 10, and the damping member 41 and the O-ring 42 are mounted to the axle 11. The O-ring 42 is located between the axle 11 and the damping member 41. The ratchet ring 32 is fixed to the hub 10 and the pawls 34 are pivotably connected to the recesses 33. The socket 21, the seat 22 and the pawls 34 are connected to the axle 11, a fixing member is used to position the socket 21 to the axle 11.

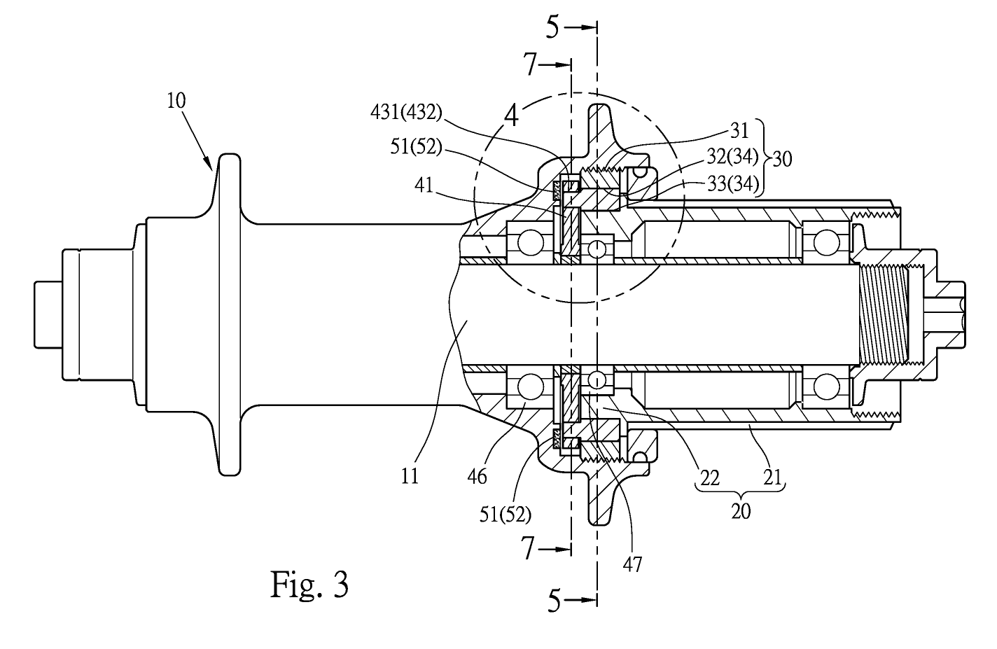

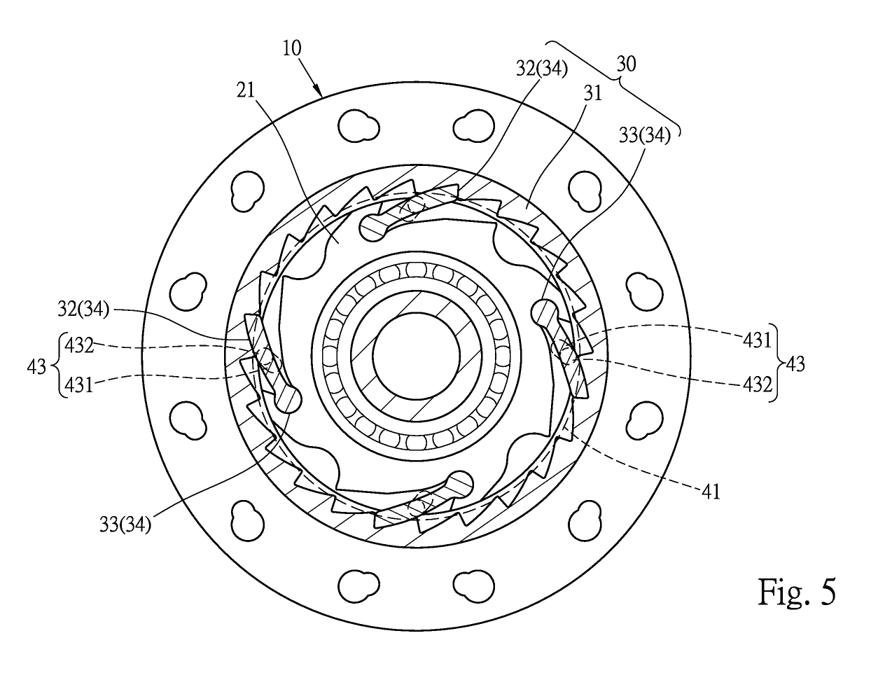

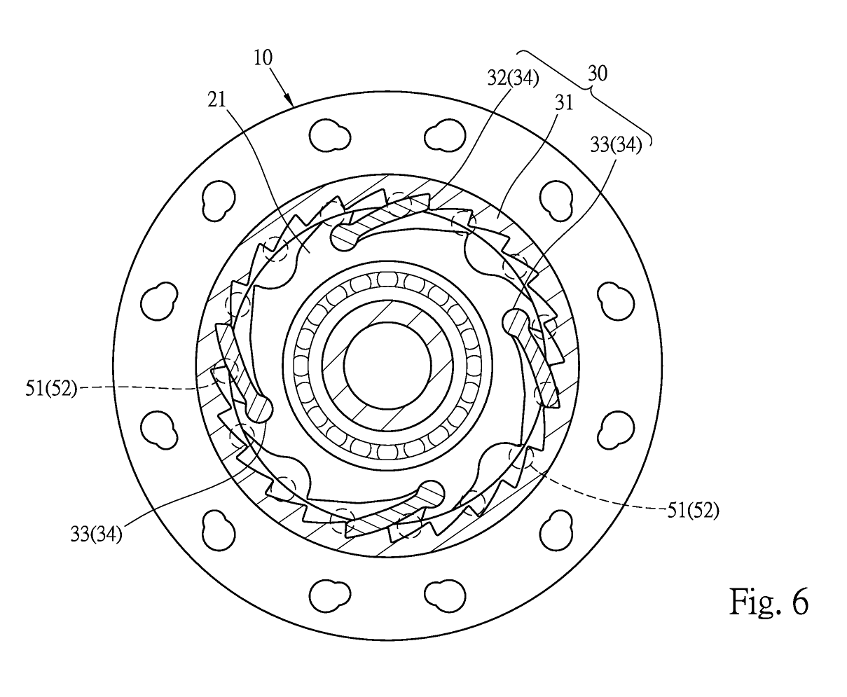

As shown in FIGS. 5 to 6, the cross sectional view taken along line 5-5 of FIG. 3 is disclosed, wherein relative positions between the seat 22, the ratchet unit 30, the damping unit 40, and the magnetic driving device 50 are disclosed. FIG. 5 discloses the relative positions between the seat 22, the pawls 34, the recesses 33, the ratchet ring 31, the ratchet teeth 32, the hub 10 and the axle 11 by solid lines, and the relative positions between the damping member 41, the elongate slots 431 and the pin 432 are disclosed by phantom lines. FIG. 6 discloses the relative positions between the seat 22, the pawls 34, the recesses 33, the ratchet ring 31, the ratchet teeth 32, the hub 10 and the axle 11 by solid lines, and the relative positions between the magnetic members 51 and the reception recesses 52 are disclosed by phantom lines.

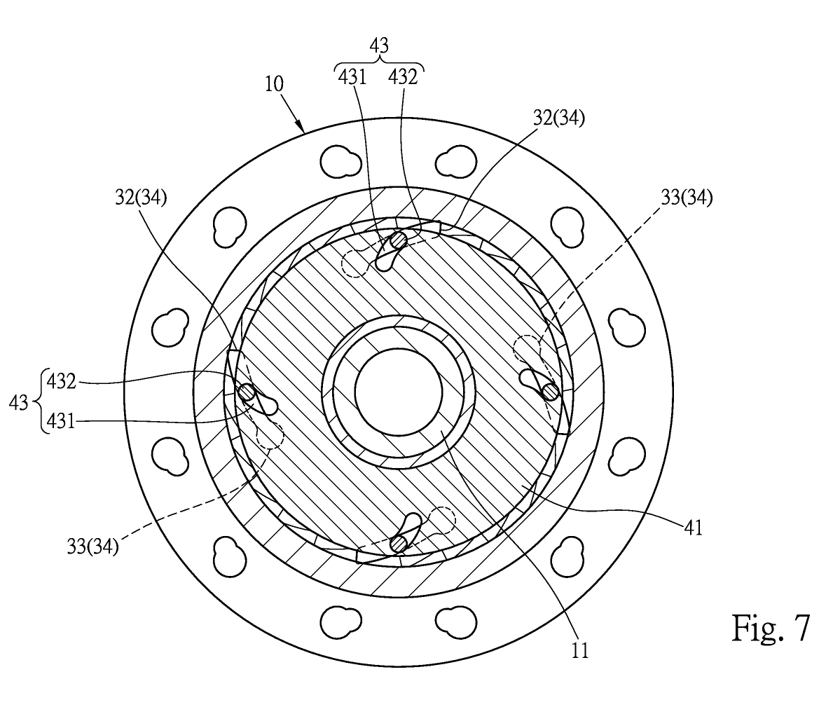

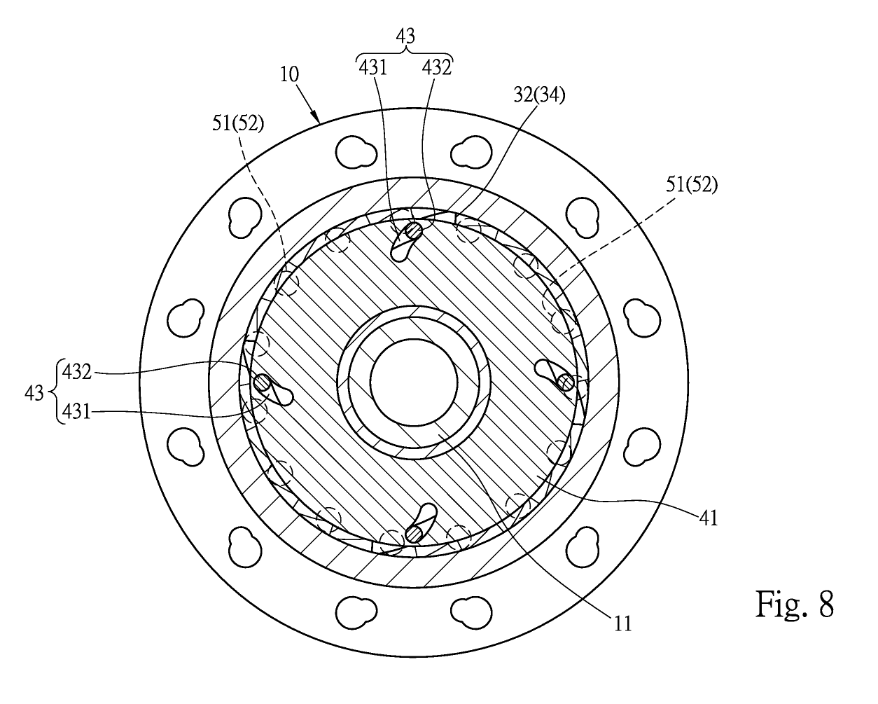

As shown in FIGS. 7 to 8, the cross sectional view taken along line 7-7 of FIG. 3 is disclosed, wherein relative positions between the ratchet unit 30, the damping unit 40 and the magnetic driving device 50 are disclosed. FIG. 7 discloses the relative positions between the damping member 41, the elongate slots 431, the pin 432, the hub 10 and the axle 11 are disclosed by solid lines, and the relative positions between the pawls 34 and the recesses 33 are disclosed by phantom lines. FIG. 8 discloses the relative positions between the damping member 41, the elongate slots 431, the pin 432, the hub 10 and the axle 11 by solid lines, and the relative positions between the magnetic members 51 and the reception recesses 52 are disclosed by phantom lines.

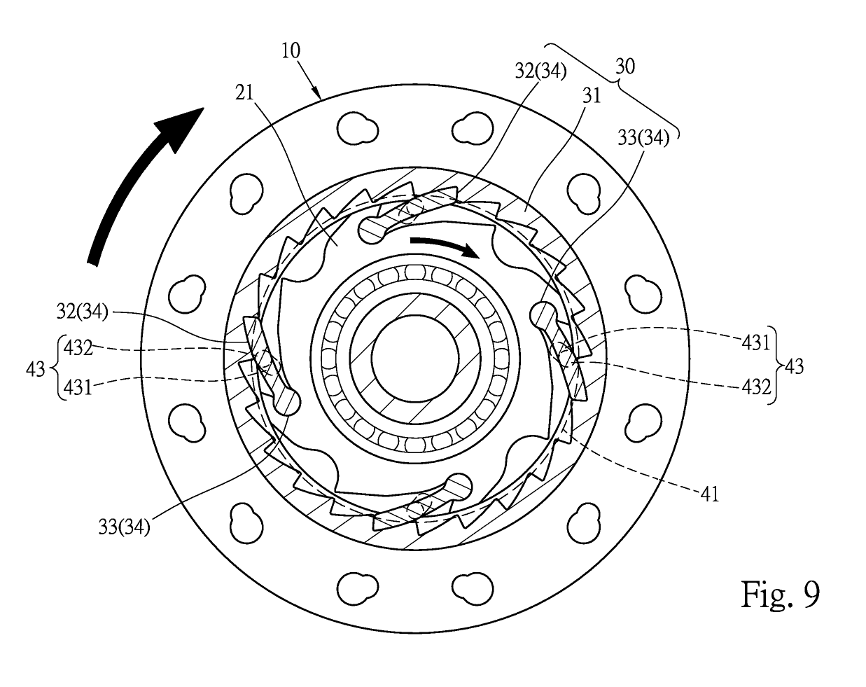

When rotating the pedals to move the bicycle forward, as shown in FIG. 9, the socket 21 is rotated, and the seat 22 and the pawls 34 are co-rotated with the set 22. The pins 432 in the slots 431 and the damping member 41 is not rotated due to the damping feature, so that the pawls 34 each have one end rotated with the socket 21, and the other end of each of the pawls 34 is moves from the inner end toward the outer end of the slot 431 because the damping member 41 is not rotated. Therefore, the pawls 34 are pivoted outward to be engaged with the ratchet teeth 32 to drive the hub and the ratchet ring 32 to rotate. Therefore, the bicycle is moved forward. When the force applied to the pawls 34 is larger than the damping feature of the damping member 41, the damping member 41 starts to rotate. In other words, there is a delay between the socket 21 and the damping member 41.

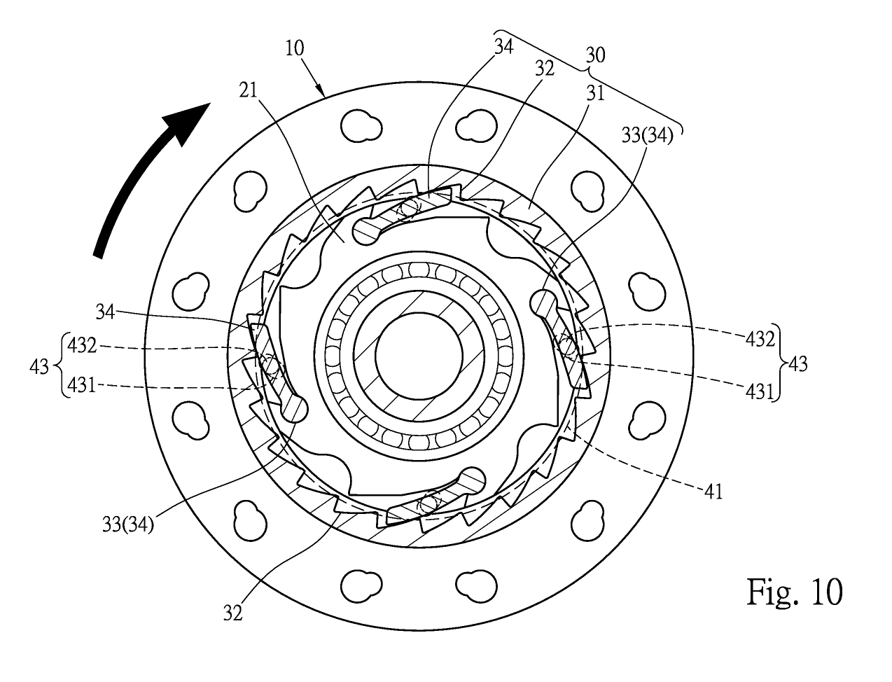

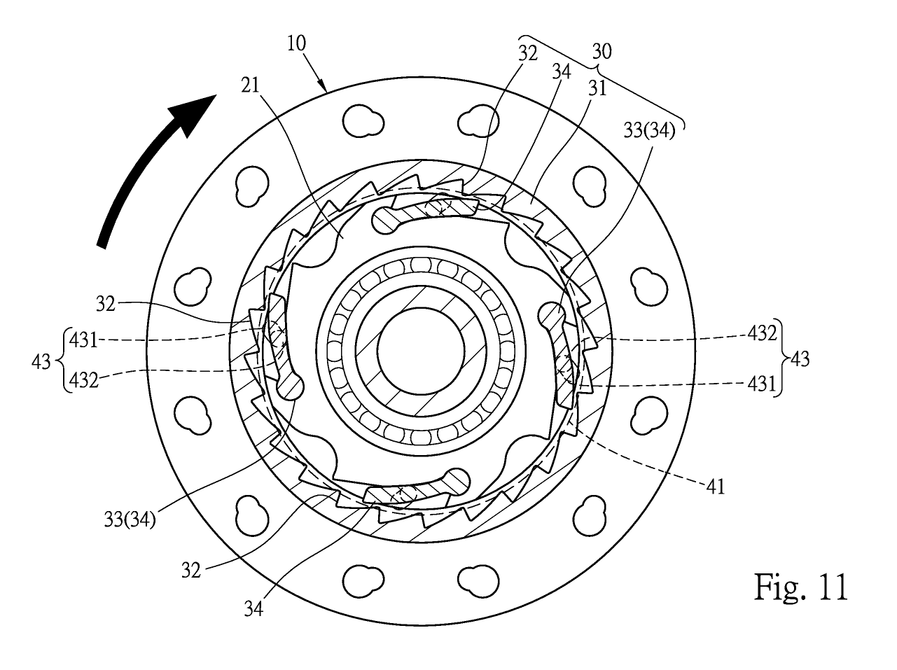

When the pedals are stopped rotating, as shown in FIGS. 10 and 11, the socket 21, the seat 22 and the pawls 34 are not rotated, while the hub 10 and the ratchet ring 32 still rotate because of the inertial force. The ratchet teeth 32 hit the distal ends of the pawls 34, and the pawls 34 are guided by the slots 431, so that each of the pins 432 moves from the outer end toward the inner end of the slot 431, such that ratchet teeth 32 do not hit the distal ends of the pawls 34. The elongate slots 431 extend toward the direction that the treading action moves the bicycle forward, so that when the pedals are not rotated, the pawls 34 do not move toward the outer end of the elongate slots 431 because the socket 21 is not rotate. The pins 432 are restricted by the elongate slots 431, and the restriction force is larger than the magnetic force of the magnetic members 51 so that the pawls 34 do not pivot outward.

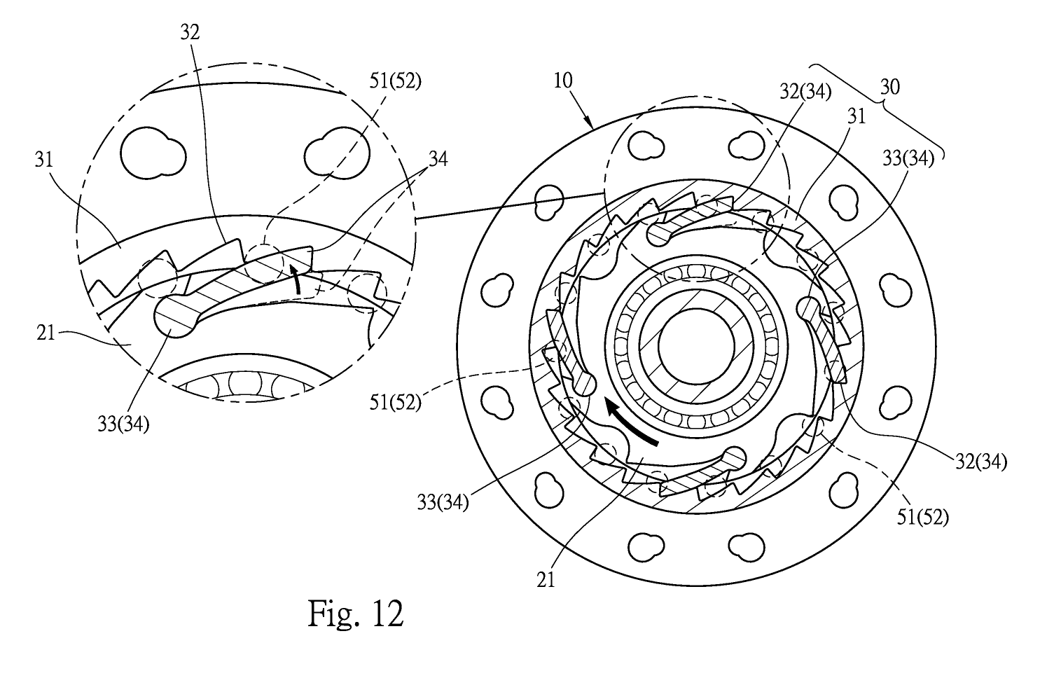

As shown in FIG. 12, when the pedals are rotated to move the bicycle forward, the socket 21 rotates to drive the pins 43 toward the outer end of each of the elongate slots 431, the pawls 34 gradually pivot outward and are engaged with the ratchet teeth 32 so that the damping member 41 and the hub 10 are co-rotated. The magnetic members 51 provide a magnetic force to assist the outward pivotal action of the pawls 34.

The damping member 41 of the present invention needs a larger force to start to rotate because of the damping feature so that the socket 21 and the damping member 41 start to rotate at different time. The delay allows the pawls 34 to be pivoted outward to be engaged with the ratchet teeth 32. The pawls 34 each have one end rotated with the seat 22, and the other end of each of the pawls 34 is moved along the slots 431 so as to pivot outward. Therefore, no resilient part is needed to pivot the pawls 34 outward.

When the pedals stop to rotate, the pawls 34 are pivoted inward to be received in the recesses 33 so that the ratchet teeth 32 do not hit the pawls 34, the noise and the friction mentioned above are disappear. The wheel can rotate for a longer period of time due to less friction applied thereto. The maintenance to the resilient parts as seen in the conventional hub assembly is saved so that the maintenance cost of the present invention is reduced. Because the pawls 34 do not hit by the ratchet teeth 32, so that the life of the pawls 34 is prolonged.

The magnetic members 51 of the magnetic driving device 50 provide a magnetic force to assist the outward pivotal action of the pawls 34 when the pawls 34 gradually pivot outward by the rotation of the socket 21 such that the pawls 34 are immediately engaged with the ratchet teeth 32, and the pivotal time of the pawls 34 is shortened. The transmission efficiency is therefore increased. It is noted that by using the magnetic force to assist the pivotal action of the pawls 34, the initial force to pivot the pawls 34 is reduced. Therefore, the impact force, as disclosed in the conventional device, between the pawls 34 and the ratchet teeth 32 is reduced. The friction and wearing are reduced, while the life of use of the pawls 34 is increased. The noise is also reduced. The magnetic force effectively match the pawls 34 with the ratchet teeth 32, so that the wearing therebetween can be reduced.

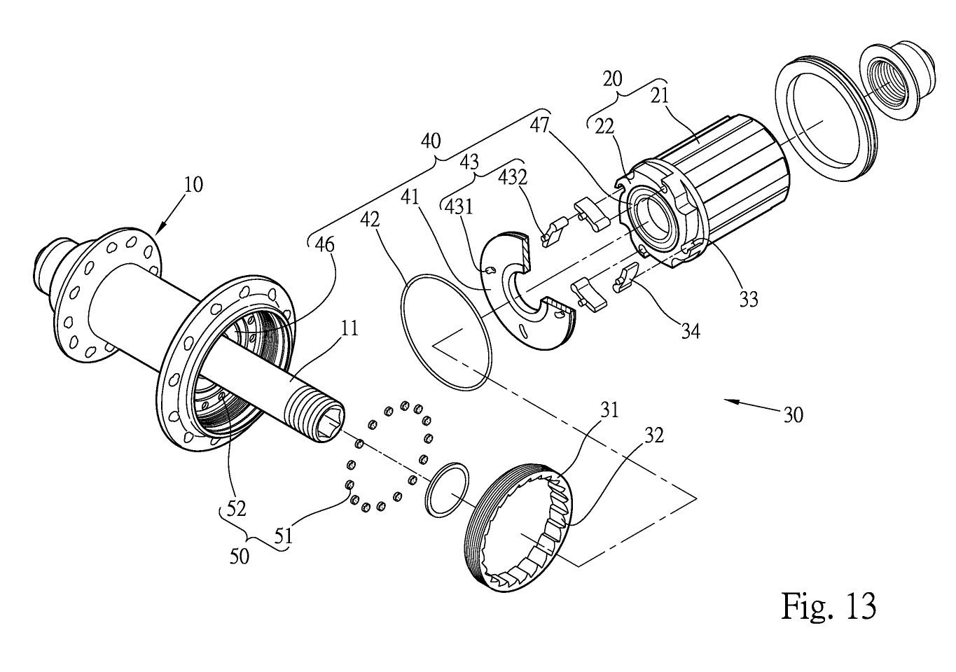

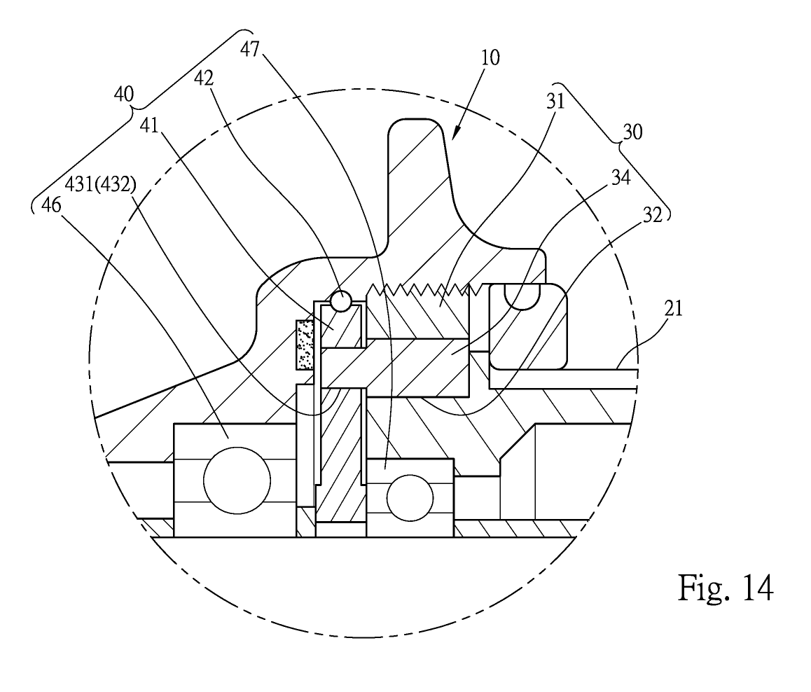

FIGS. 13 to 14 show the second embodiment of the present invention wherein the damping member 41 mounted to the axle 11 and located between the hub 10 and the damping member 41. The O-ring 42 is located between the hub 10 and the damping member 41 so as to generate the damping feature. The damping feature works at another position of the damping member 41 so as to delay the rotation of the damping member 41. The same function as the first embodiment can be obtained.

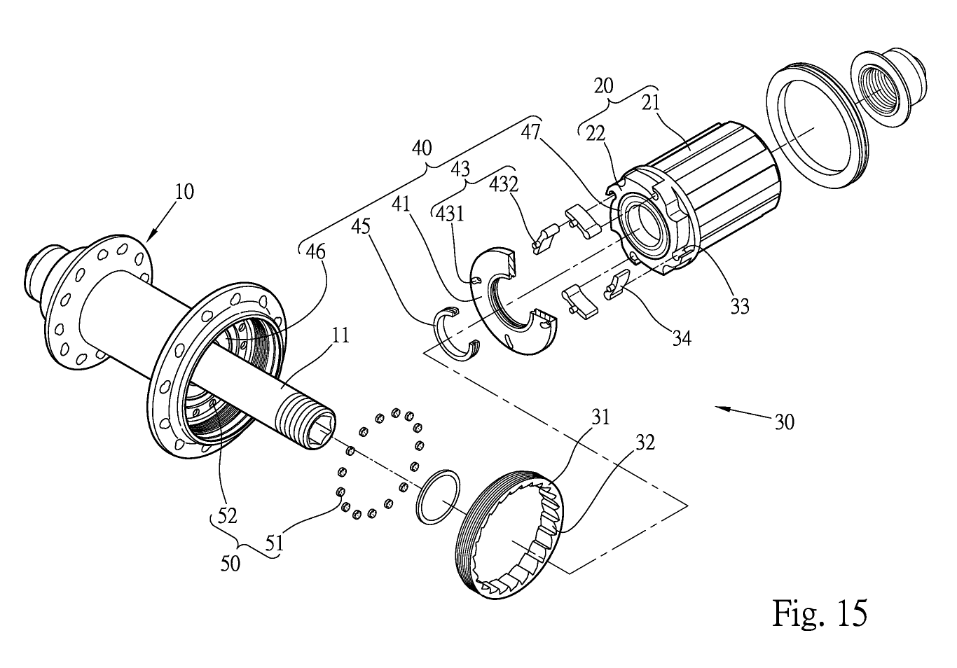

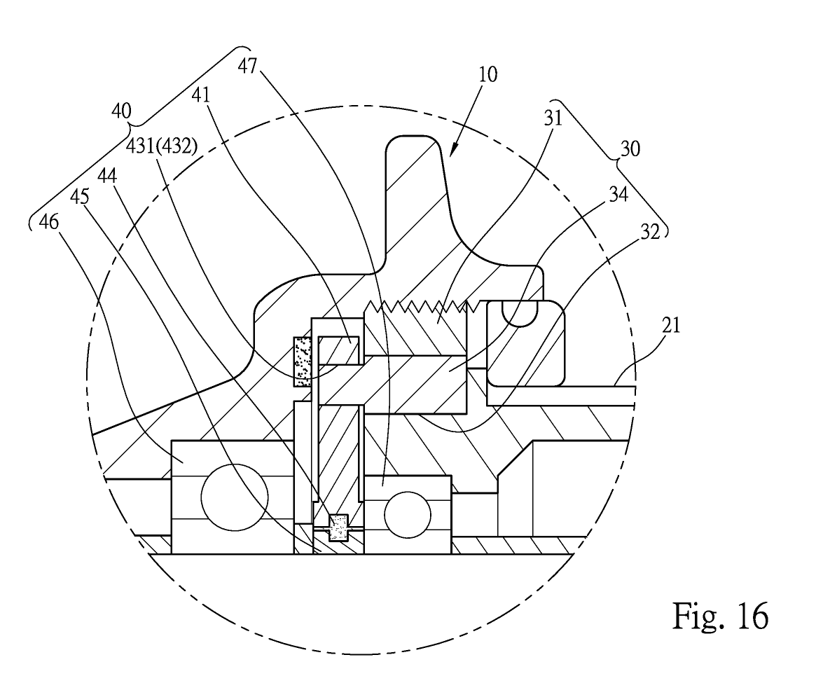

FIGS. 15 to 16 show the third embodiment of the present invention wherein the damping unit 40 has a mounting ring 45 which is mounted to the axle 11. The damping member 41 is mounted to the outer periphery of the mounting ring 45. The inner periphery of the damping member 41 and the outer periphery of the mounting ring 45 each have a groove 44. The two respective grooves 44 are located corresponding to each other to from an annular space in which damping liquid is filled so as to delay the rotation of the damping member 41.

A first bearing 46 and a second bearing 47 are located on two sides of the mounting ring 45, wherein the outer periphery of the first bearing 46 is fixed to the inside of the hub, and the outer periphery of the second bearing 47 is fixed to the inside of the socket 21. Therefore, the two sides of the mounting ring 45 are in contact with the first and second bearings 46, 47 such that the rotation of the first and second bearings 46, 47 is smooth.

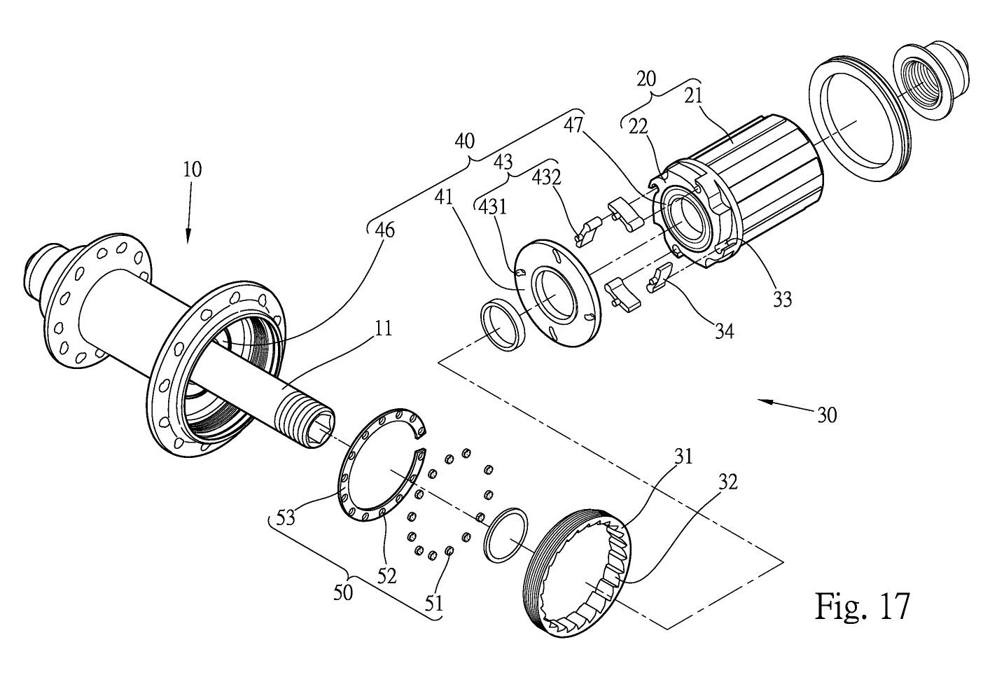

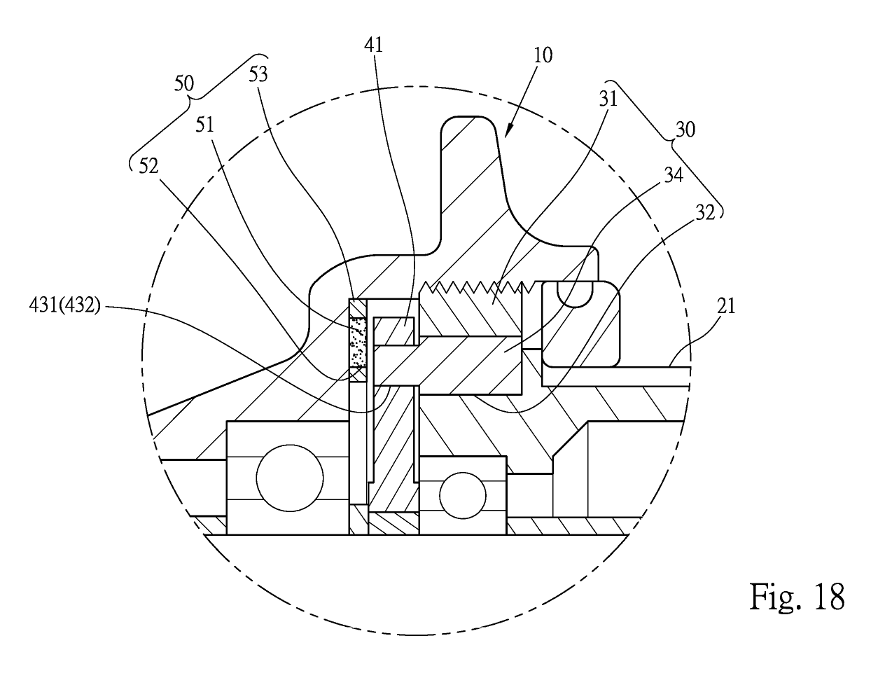

FIGS. 17 and 18 show the fourth embodiment of the present invention, wherein the magnetic driving device 50 has a reception base 53 which is connected to the hub 10 and is a C-shaped base. Multiple reception recesses 52 are defined in the reception base 53, each of the reception recesses 52 has one of the magnetic members 51 received therein. The reception recesses 52 are integrally defined in the reception base 53, and the magnetic members 51 are received in the reception recesses 52 one by one.

Another embodiment of the magnetic driving device has a C-shaped reception base 53, the shape allows the reception base 53 to be compressible so that the C-shaped reception base 53 can be compressed to a smaller size before installed into the hub 10. When the reception base 53 is installed in the hub 10, the reception base 53 is released which bounced back and is engaged with the inside of the hub 10. This feature is convenient for installation.

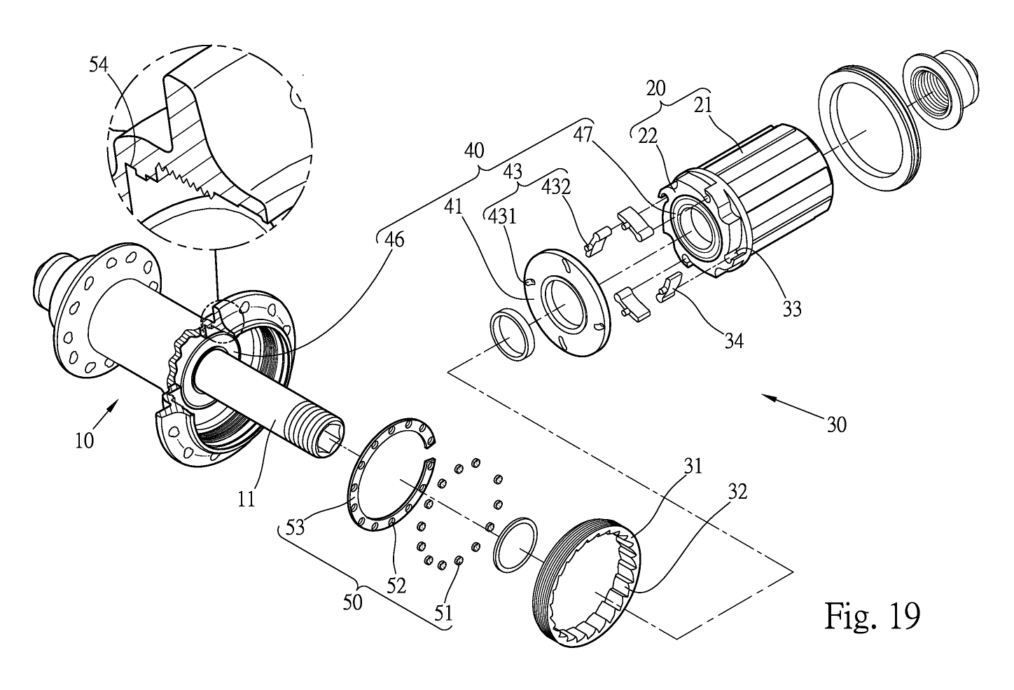

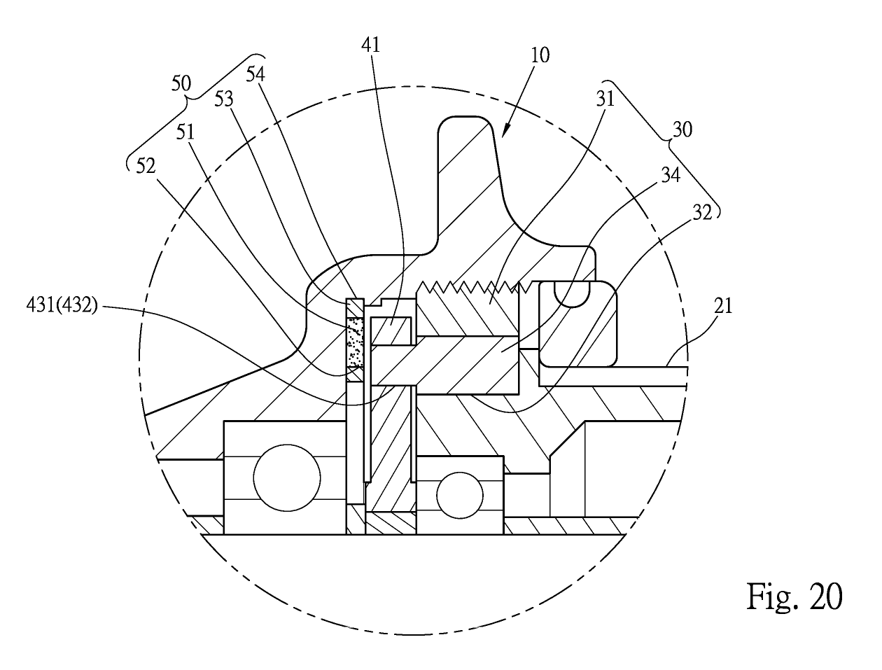

As shown in FIGS. 19 and 20, a fifth embodiment of the present invention is disclosed, wherein the inside of the hub 10 has an engaging groove 54, and the reception base 53 is engaged with the engaging groove 54 which ensures that the reception base 53 is well positioned.

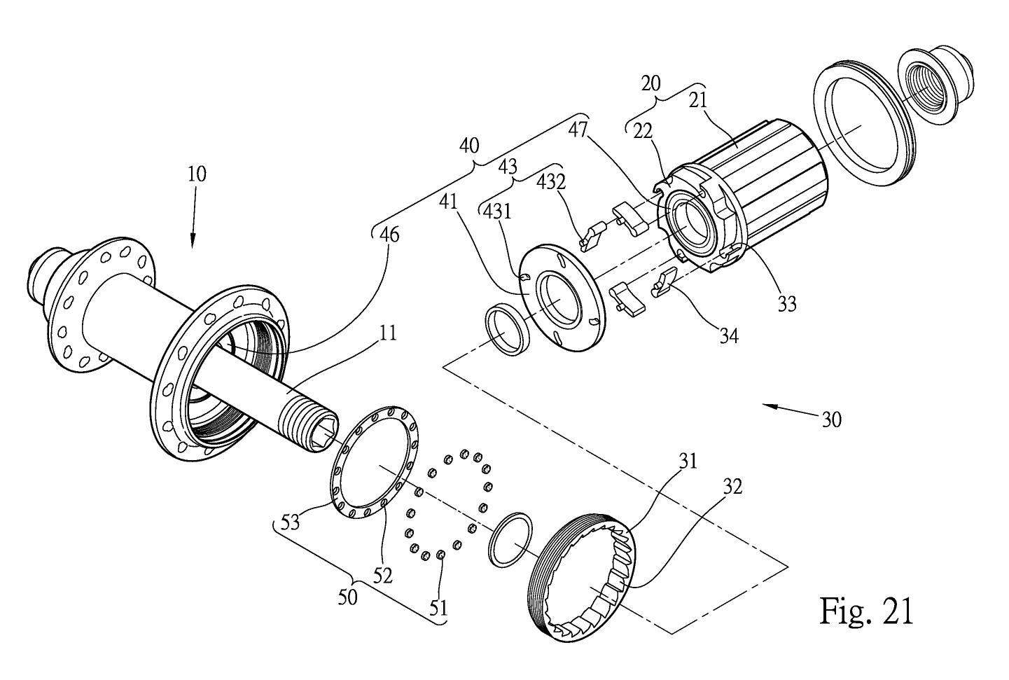

As shown in FIG. 21, a sixth embodiment of the present invention is disclosed, wherein the magnetic driving device 50 has a reception base 53 which is a ring-shaped and thin base. The reception base 53 has reception recesses 52 defined therein and each reception recess 52 receives one magnetic member 51 therein. When assembling, the magnetic members 51 are connected to the reception base 53, and the combination of the reception base 53 and the magnetic member 51 is installed in the inside of the hub 10.

The bicycle ratchet hub assembly has a damping unit 40 which guides the pawls 34 to be pivoted outward to be engaged with the ratchet teeth 32 without using any resilient part. Therefore, the maintenance cost is reduced. The pawls 34 are stored in the recesses 33 so that the friction between the ratchet teeth 32 and the pawls 34 is reduced. The magnetic driving device 50 provides magnetic force to assist the pawls 34 to pivot outward to increase the efficiency of transmission.

While we have shown and described the embodiment in accordance with the present invention, it should be clear to those skilled in the art that further embodiments may be made without departing from the scope of the present invention.

What is claimed is:

1. A bicycle ratchet hub assembly comprising:
a hub and an axle extending through the hub which is rotatable relative to the axle;
a ratchet unit connected to one end of the hub and having a seat and a socket, the socket being adapted to be connected with a freewheel gear cluster;
a ratchet unit located between the hub and the socket unit, the ratchet unit having a ratchet ring located therein, the ratchet ring having multiple ratchet teeth defined in an inner periphery thereof, at least one recess defined in the seat and a metal pawl pivotably engaged with the at least one recess, the pawl being pivoted radially and outward from the at least one recess so as to be engaged with the ratchet teeth of the ratchet ring to drive the hub;
a damping unit having a damping member mounted to the axle and located in the hub, a damping feature formed between the axle and the damping member, a guiding unit having at least one slot defined in the damping member, the pawl having a pin which movably extends through the at least one slot, the damping member providing a force to the pawl, the pin being moved within the at least one slot to guide the pawl to be engaged with or to be disengaged from the ratchet teeth of the ratchet ring, and
a magnetic driving device located between the hub and the ratchet unit, the hub having at least one magnetic member connected thereto which is located close to a position where the pawl pivots outward, the at least one magnetic member providing a attracting force to the pawl so that when the pawl pivots outward, the at least one magnetic member attracts the pawl to pivot outward.

2. A bicycle ratchet hub assembly comprising:
a hub and an axle extending through the hub which is rotatable relative to the axle;
a ratchet unit connected to one end of the hub and having a seat and a socket, the socket being adapted to be connected with a freewheel gear cluster;
a ratchet unit located between the hub and the socket unit, the ratchet unit having a ratchet ring located therein, the ratchet ring having multiple ratchet teeth defined in an inner periphery thereof, at least one recess defined in the seat and a metal pawl pivotably engaged with the at least one recess, the pawl being pivoted radially and outward from the at least one recess so as to be engaged with the ratchet teeth of the ratchet ring to drive the hub;
a damping unit having a damping member mounted to the axle and located in the hub, a damping feature formed between the hub and the damping member, a guiding unit having at least one slot defined in the damping member, the pawl having a pin which movably extends through the at least one slot, the damping member providing a force to the pawl by the damping feature, the pin being moved within the at least one slot to guide the pawl to be engaged with or to be disengaged from the ratchet teeth of the ratchet ring, and
a magnetic driving device located between the hub and the ratchet unit, the hub having at least one magnetic member connected thereto which is located close to a position where the pawl pivots outward, the at least one magnetic member providing a attracting force to the pawl so that when the pawl pivots outward, the at least one magnetic member attracts the pawl to pivot outward.

3. The bicycle ratchet hub assembly as claimed in claim 1, wherein an O-ring is located between the axle and the damping member so as to generate the damping feature.

4. The bicycle ratchet hub assembly as claimed in claim 2, wherein an O-ring is located between the hub and the damping member so as to generate the damping feature.

5. The bicycle ratchet hub assembly as claimed in claim 1, wherein the damping member has a groove defined in an inner periphery thereof, the axle extends through the inner periphery of the damping member, damping liquid is filled in the groove.

6. The bicycle ratchet hub assembly as claimed in claim 2, wherein the damping member has a groove which is located at a position where the hub is connected with the damping member, damping liquid is filled in the groove.

7. The bicycle ratchet hub assembly as claimed in claim 1, wherein the damping member is made of Teflon.

8. The bicycle ratchet hub assembly as claimed in claim 2, wherein the damping member is made of Teflon.

9. The bicycle ratchet hub assembly as claimed in claim 1, wherein the pin is connected to one side of the pawl and faces the damping member.

10. The bicycle ratchet hub assembly as claimed in claim 2, wherein the pin is connected to one side of the pawl and faces the damping member.

11. The bicycle ratchet hub assembly as claimed in claim 1, wherein when the socket unit is rotated in a direction that the ratchet unit rotates, the pin of the pawl is moved from an inner end toward an outer end of the at least one slot while the damping member is maintained stationary, the pawl is pivoted outward and engaged with the ratchet teeth.

12. The bicycle ratchet hub assembly as claimed in claim 2, wherein when the socket unit is rotated in a direction that the ratchet unit rotates, the pin of the pawl is moved from an inner end toward an outer end of the at least one slot while the damping member is maintained stationary, the pawl is pivoted outward and engaged with the ratchet teeth.

13. The bicycle ratchet hub assembly as claimed in claim 1, wherein the damping unit has a mounting ring which is mounted to the axle, the damping member is mounted to an outer periphery of the mounting ring, an inner periphery of the damping member and an outer periphery of the mounting ring each have a groove, the two respective grooves are located corresponding to each other, damping liquid is filled in the two respective grooves.

14. The bicycle ratchet hub assembly as claimed in claim 2, wherein the damping unit has a mounting ring which is mounted to the axle, the damping member is mounted to an outer periphery of the mounting ring, an inner periphery of the damping member and an outer periphery of the mounting ring each have a groove, the two respective grooves are located corresponding to each other, damping liquid is filled in the two respective grooves.

15. The bicycle ratchet hub assembly as claimed in claim 1, wherein the magnetic driving device has at least one reception recess which is defined in the hub, the at least one magnetic member is engaged with the at least one reception recess.

16. The bicycle ratchet hub assembly as claimed in claim 2, wherein the magnetic driving device has at least one reception recess which is defined in the hub, the at least one magnetic member is engaged with the at least one reception recess.

17. The bicycle ratchet hub assembly as claimed in claim 1, wherein the magnetic driving device has a reception base connected to the hub, the reception base has at least one reception recess defined therein, the at least one magnetic member is engaged with the at least one reception recess.

18. The bicycle ratchet hub assembly as claimed in claim 2, wherein the magnetic driving device has a reception base connected to the hub, the reception base has at least one reception recess defined therein, the at least one magnetic member is engaged with the at least one reception recess.

19. The bicycle ratchet hub assembly as claimed in claim 12, wherein the reception base is a ring-shaped base, multiple reception recesses are defined in the reception base, each of the reception recesses has one of the magnetic members received therein.

20. The bicycle ratchet hub assembly as claimed in claim 12, wherein the reception base is a C-shaped base, multiple reception recesses are defined in the reception base, each of the reception recesses has one of the magnetic members received therein.
